(19) United States
(12) Patent Application Publication
(10) Pub. No.: US 2011/0211587 A1
(43) Pub. Date: Sep. 1, 2011

(54) Packet Relaying Device, Packet Relaying Method And Program

(75) Inventors: Tetsuya Murakami, San Jose, CA (US); Satoru Matsushima, Chiba (JP)

(73) Assignees: SOFTBANK BB CORP., Tokyo (JP); ACCESS CO., LTD., Tokyo (JP)

(21) Appl. No.: 13/125,800

(22) PCT Filed: Oct. 29, 2010
(86) PCT No.: PCT/JP2010/069302

§ 371 Date: Apr. 22, 2011

(30) Foreign Application Priority Data
Oct. 30, 2009 (JP) 2009-251363

(51) Int. Cl. H04L 12/56

(52) U.S. Cl. 370/401

(57) ABSTRACT

A packet relaying device, wherein a reception processing unit judges an interface used to receive an IP packet from a network, and records a reception interface identifier (RID) which is information for identifying the interface, in a packet transmission/reception management table, a route control unit records, in the packet transmission/reception management table, a transmission interface identifier (SID) which is information for identifying the transmission interface obtained by selection of a transmission path and the above described reception interface identifier (RID), in such a manner that the identifies are associated with each other. A transmission processing unit makes a comparison between the reception interface identifier (RID) and the transmission interface identifier (SID) recorded in the packet transmission/reception management table, and when the both identifiers are the interface identifier of the same virtual network interface, the transmission processing unit discards the IP packet to invalidate the transmission process.

### TECHNICAL FIELD

The present invention relates to a packet relaying device, a packet relaying method and a program for relaying a packet between networks.

### BACKGROUND OF THE INVENTION

On the internet, tunneling technology is used in many cases. The tunneling constitutes a virtual network by which a two-point link is provided on a physical network environment based on a physical medium.

Incidentally, with regard to the tunneling, occurrence of an infinite loop, where a packet which has passed through a virtual network is sent to the same virtual network again as a result of route control, has been pointed out as a problem. Specifically, in general a header of a packet includes TTL (Time to Live) or hop limit which indicates a lifetime of a packet in routing. Typically, when the lifetime of the packet indicated by such a parameter reaches to zero, the packet is discarded to prevent occurrence of a loop of the packet. However, when the tunneling is performed, a header for encapsulation is added to a packet, and TTL or hop limit (i.e., a lifetime of a packet) is updated. In this case, the packet is not discarded, and thereby an infinite loop where the packet is endlessly transferred is caused. Depending on the type of tunneling, there is a case where a new capsule header is added to a packet each time the packet makes one rotation in the loop. In this case, a problem arises that the size of the packet gradually increases, and thereby a consumed band of the line also increases.

To prevent occurrence of such an infinite loop of a packet, some technologies for detecting occurrence of a loop of a packet have been proposed. For example, Japanese Domestic Re-publication of PCT International Publication (No. 2009-514265A1) (hereafter, referred to as patent document #1) discloses that an identifier is inserted into a header of a packet, and occurrence of a loop is detected based on the identifier. Specifically, in a system of the patent document #1, a node which transmits a packet encapsulates a transmission packet by inserting an identifier for identifying itself into a header of the transmission packet. A tunnel packet generated by the encapsulation is transferred to a next node. Then, the node which has received the tunnel packet judges whether the identifier inserted into the header is equal to its own identifier. When the identifier is not equal to its own identifier, the node encapsulates the tunnel packet by inserting the same identifier, which has been originally inserted into the tunnel packet, into the header of the tunnel packet, and transfers the tunnel packet to a next node. When the tunnel packet being repeatedly transferred returns to the node which has initially transmitted the tunnel packet, the node judges that the identifier inserted into the received tunnel packet is equal to its own identifier. Thus, a tunneling loop is detected.

### DISCLOSURE OF THE INVENTION

### Problem to be Solved by the Invention

However, according to the technology for detecting the tunneling loop disclosed in the patent document #1, it is necessary to modify the structure of the packet to detect the tunneling loop, and it is necessary to implement a configuration for inserting or confirming an identifier on all of the nodes on the network. Therefore, it is not easy to introduce the technology disclosed in the patent document #1 into a global network, such as the internet.

In view of the above described circumstances, the object of the present invention is to provide an packet relaying device and a packet relaying method capable of preventing occurrence of an infinite loop without modifying a structure of a packet.

### Means for Solving the Problem

To achieve the above described object, a packet relaying device according to an embodiment of the invention includes: a plurality of interfaces including a virtual network interface; a reception processing unit configured to receive a packet through one of the plurality of interfaces; a route control unit configured to execute a route selection to determine, from among the plurality of interfaces, an interface used to transmit the received packet; and a transmission processing unit configured to discard the received packet when the interface which was used to receive the packet in the reception processing unit and the interface determined by the route control unit are identical with each other, and are the virtual network interface.

With this configuration, it becomes possible to prevent occurrence of an infinite loop of a packet where the packed received from a network is transmitted to the network again through the same interface as the reception interface which was used to receive the packet. Furthermore, according to the invention, the transmission processing unit compares the reception interface with the transmission interface, and when the both interfaces are the same virtual network interface, the transmission processing unit discards the received packet to prevent occurrence of an infinite loop. Therefore, there is no need to modify the structure of the packet.

The transmission processing unit may be configured to execute a transmission process for the packet through the interface determined by the route control unit when the interface which was used to receive the packet in the reception processing unit and the interface determined by the route control unit are not identical with each other, or when the interface which was used to receive the packet in the reception processing unit and the interface determined by the route control unit are identical with each other but are not the virtual network interface.

The packet relaying device according to the invention may further include a storage unit configured to store a reception interface identifier for identifying the interface which was used to receive the packet and a transmission interface identifier for identifying the interface determined to be used for transmission of the packet, in such a manner that the reception interface identifier and the transmission interface identifier are associated with each other. The reception processing unit may store, in the storage unit, an identifier of the interface which was used to receive the packet, as the reception interface identifier. The route control unit may store, in the storage unit, an identifier of the interface determined by the route selection, as the transmission interface identifier. The transmission processing unit may make a comparison between the reception interface identifier and the transmission interface identifier stored in the storage unit.

The plurality of interfaces of the packet relaying device according to the invention may be logical ports.

According to another aspect of the invention, there is provided a packet relaying method, including the steps of: receiving a packet through one of a plurality of interfaces including a virtual network interface; executing a route selection to determine, from among the plurality of interfaces, an interface used to transmit the received packet; and discarding the received packet when the interface which was used to receive the packet and the interface determined by the route selection are identical with each other, and are the virtual network interface. According to the invention, there is provided a program causing a computer to execute the above described packet relaying method.

### Advantage of the Invention

As described above, according to the invention, it becomes possible to prevent occurrence of an infinite loop without modifying a structure of a packet.

### BRIEF DESCRIPTION OF THE DRAWINGS

FIG. 1 is an explanatory illustration for explain a packet relay process by a typical tunneling.

FIG. 2 is a block diagram illustrating a configuration of a host which is a packet relaying device according to an embodiment of the invention

FIG. 3 illustrates an example of a packet transmission/reception management table in the host shown in FIG. 2.

FIG. 4 illustrates an example of a concrete hardware configuration of the host shown in FIG. 2.

FIG. 5 is a flowchart illustrating a packet relay process executed by the host shown in FIG. 2.

FIG. 6 illustrates an example of transition of the packet transmission/reception management table in the packet relay process shown in FIG. 5.

### BEST MODE FOR CARRYING OUT THE INVENTION

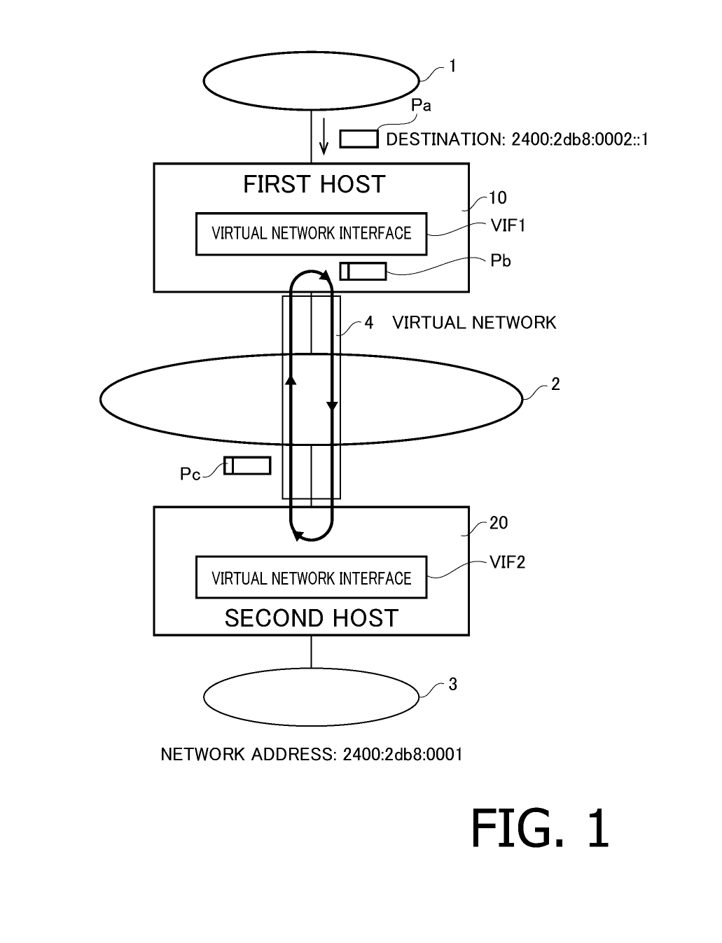

In the following, an embodiment according to the invention is described with reference to the accompanying drawings. FIG. 1 is an explanatory illustration for explain a packet relay process by a typical tunneling. In FIG. 1, a first host 10 is a router interconnecting a first network 1 and a second network 2, a second host 20 is a router interconnecting the second network 2 and a third network 3. The first and second hosts 10 and 20 are virtually connected with each other through a virtual network 4 based on tunneling which uses the second network 2 as a physical medium. For example, when each of the first network 1 and the third network 3 is an IPv6 network and the second network 2 is an IP v4 network, the virtual network 4 is constituted by an IPv6 over IPv4 tunneling.

When the first host 10 receives an IP packet Pa having a destination address “2400:2db8:0002::1”, the first host 10 refers to a routing table (not shown) based on a network address in the destination address of the IP packet Pa and selects a transmission path of the IP packet Pa. When a transmission interface determined by the selected path is a virtual network interface VIF1 corresponding to the virtual network 4, the first host 10 passes the IP packet Pa to the virtual network interface VIF1.

The virtual network interface VIF1 is a tunnel interface, and generates an IP packet Pb which is encapsulated by adding an IPv4 header (i.e., an IPv4 address of the first host 10 being a sender, and an IPv4 address of the second host 20 being a destination) to the IP packet Pa for transferring through the virtual network 4. Then, the IP placket Pb generated by the virtual network interface VIF1 is transmitted to the second network 2.

The second host 20 receives, from the second network 2, the IP packet Pb addressed to itself by using the virtual network interface VIF2. The virtual network interface VIF2 obtains the IP packet Pa and decapsulates the received IP packet Pb. Then, the decapsulated IP packet Pa is passed to a module (not shown) which operates based on a network protocol, and thereafter a process based on the protocol is executed similarly to an ordinary case.

When the IP packet Pa is not addressed to the second host 20, the second host 20 executes a transferring process for the IP packet Pa. Specifically, first, the second host 20 refers to a routing table (not shown) based on a network address in the destination address contained in the IP packet Pa, and makes a selection of a transmission path for the IP packet Pa. Then, based on the selected transmission path, the second host 20 transfers the IP packet Pa. When a path corresponding to the destination address of the IP packet Pa is not found in the routing table (i.e., when the network address “2400:2db8:0002” in the destination address of the IP packet Pa does not match the network address “2400:2db8:0001” of the third network 3), the second host 20 selects a path to return the IP packet Pa to the first host 10, and passes the IP packet Pa to the virtual network interface VIF2.

In the virtual network interface VIF2, an IPv4 header for transferring on the virtual network 4 (i.e., the IPv4 address of the second host 20 being a sender and the IPv4 address of the first host 10 being a destination) is added to the IP packet Pa to generate an IP packet Pc. The IP packet Pc generated in the virtual network interface VIF2 is transferred to the first host 10 through the virtual network 4. The first host 10 which has received the IP packet Pc returned from the second host 20 controls the virtual network interface VIF1 to decapsulate the received IP packet Pc, and obtains the IP packet Pa. Then, similarly to the above described path selection, the first host 10 selects a transmission path based on the destination address of the IP packet Pa, generates again the IP packet Pb, and transmits the IP packet Pb to the second host 20. As a result, an infinite loop where the IP packet is endlessly transferred between the first host 10 and the second host 20 occurs.

As a factor causing the above described infinite loop, a setting miss, where the transmission interface of the IP packet Pa is erroneously set to the virtual network interface VIF1 corresponding to the virtual network 4 due to erroneously set routing table on the first host 10, is considered. As another factor causing the above described infinite loop, a setting miss, where the transmission interface determined by the transmission path of the IP packet Pa is set to the virtual network interface VIF2 corresponding to the virtual network 4 due to erroneously set routing table on the second host 20, is cited.

By contrast, the packet relaying device according to the embodiment is able to prevent occurrence of an infinite loop which would be caused, for example, by a setting miss of the routing table, without the need for changing the structure of an IP packet.

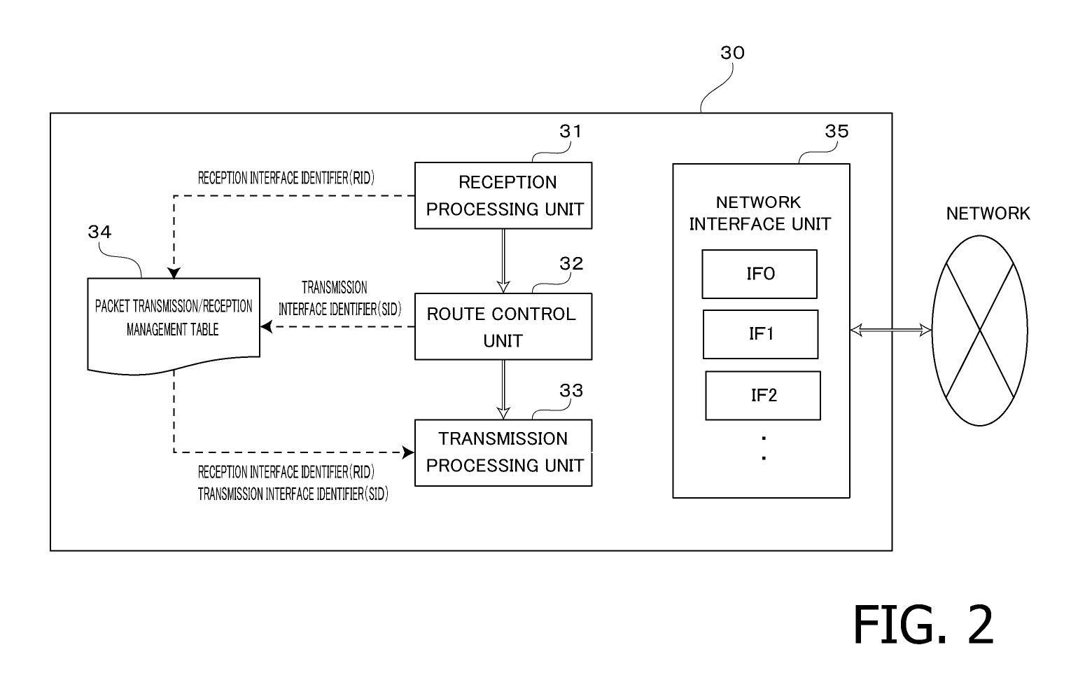

FIG. 2 is a block diagram illustrating a configuration of a host 30 which is a packet relaying device according to the embodiment of the invention. Although the host 30 can be employed in any of the first host 10 and the second host 20 shown in FIG. 1, in this embodiment we consider the case where the host 30 is employed as the second host 20. As shown in FIG. 2, the host 30 includes a reception processing unit 31, a route control unit 32, a transmission processing unit 33, a packet transmission/reception management table 34, and a network interface unit 35.

The reception processing unit 31 executes a reception process for an IP packet by using one of a plurality of interfaces (IF0, IF1, IF2, . . . ) of the network interface unit 35. Further, the reception processing unit 31 records, in the packet transmission/reception management table 34, a reception interface identifier (RID) which is information for identifying the interface used to receive the IP packet.

The route control unit 32 selects a transmission path of the IP packet received by the reception processing unit 31 based on a routing table. Further, the reception control unit 32 determines a transmission interface of the IP packet in accordance with the selected transmission path, and records, in the packet transmission/reception table 34, the transmission interface identifier (SID) which is information for identifying the determined transmission interface, in such a manner that the transmission interface identifier (SID) is associated with the above described reception interface identifier (RID).

The transmission processing unit 33 transmits the IP packet to a network through one of the plurality of interfaces (IF0, IF1, IF2, . . . ) in the network interface unit 35, based on the packet transmission/reception management table 34. Specifically, the transmission processing unit 33 makes a comparison between the reception interface identifier (RID) with the transmission interface identifier (SID) recorded in the packet transmission/reception management table 34. When the reception interface identifier (RID) matches the transmission interface identifier (SID) and both of them are identifiers for the virtual network interface, the transmission processing unit 33 discards the IP packet to invalidate the transmission process. In other cases, the transmission processing unit 33 transmits the IP packet to a network through an interface indicated by the transmission interface identifier (SID).

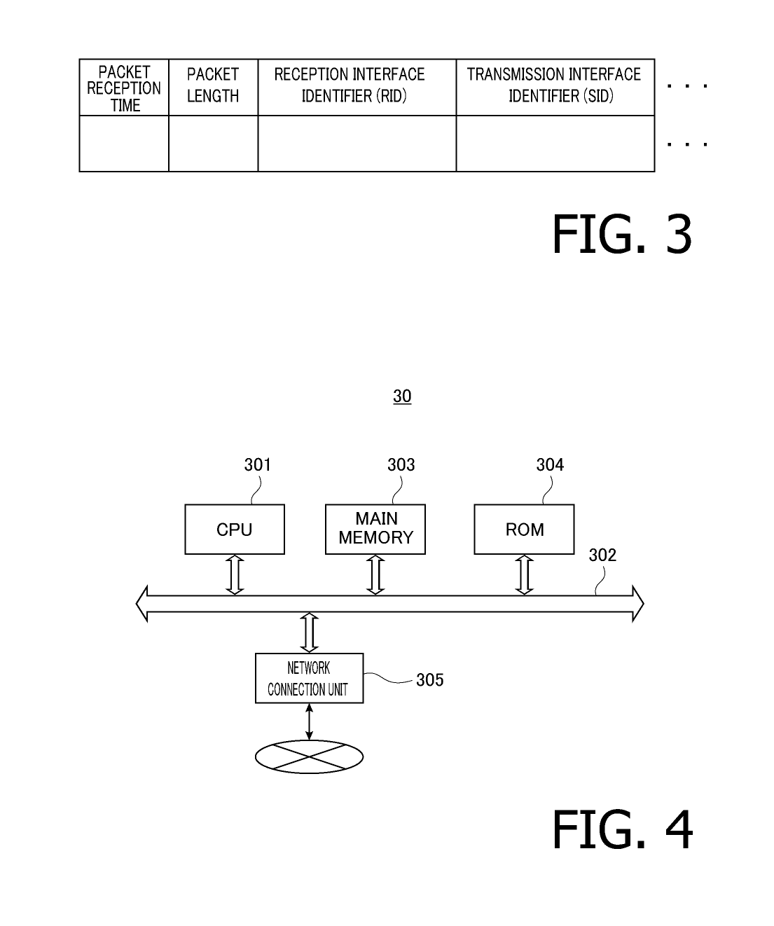

As shown as an example in FIG. 3, the packet transmission/reception management table 34 is a table in which a reception time of the received IP packet, a packet length, the reception interface identifier (RID), the transmission interface identifier (SID) are temporarily recorded in association with each other. The information for each packet recorded in the packet transmission/reception management table 34 is deleted, for example, after the comparison between the reception interface identifier (RID) and the transmission interface identifier (SID) is completed by the transmission processing unit 33.

The network interface unit 35 is a logical port which executes a transmission/reception process, such as encapsulation or decapsulation, for the IP packet transmitted or received through a physical port. These interfaces of the network interface unit 35 include an Ethernet® interface (IF0), a PPPoE (Point to Point Protocol over Ethernet) interface (IF1) and a virtual network interface (IF2).

FIG. 4 illustrates an example of a concrete hardware configuration of the host 30. As shown in FIG. 4, the host 30 is a computer which includes a CPU (Central Processing Unit) 301, a system bus 302, a main memory 303, a ROM (Read Only Memory) 304 and a network connection unit 305.

The ROM 304 stores software including various types of data and programs which cause the host 30 to function as the reception processing unit 31, the route control unit 32, the transmission processing unit 33 and the network interface unit 35, and a log which is explained later. In the main memory 303, the software such as various types of data and a program stored in the ROM 304 is loaded. The CPU 301 executes the packet relay process which is described later, in accordance with the program loaded in the main memory 303. Furthermore, in the main memory 303, the packet transmission/reception management table 34 is also stored. The ROM 304 may be a rewritable ROM, such as a flash ROM, so that the program and the various types of data can be rewritten with the latest data.

The network connection unit 305 includes a plurality of physical ports for connecting to a wide area network such as a Ethernet, or a local network such as a home network via a wireless or wired line. The packet addressed to the host 30 is received by the network connection unit 305 which is a physical port, and is passed to one of the interfaces (IF0, IF1, IF2, . . . ) corresponding to the IP packet. For example, when an encapsulated IP packet is received by the network connection unit 305, the IP packet is sent to the virtual network interface (IF2). It should be noted that, a plurality of network connection units 305 may be provided in the host 30.

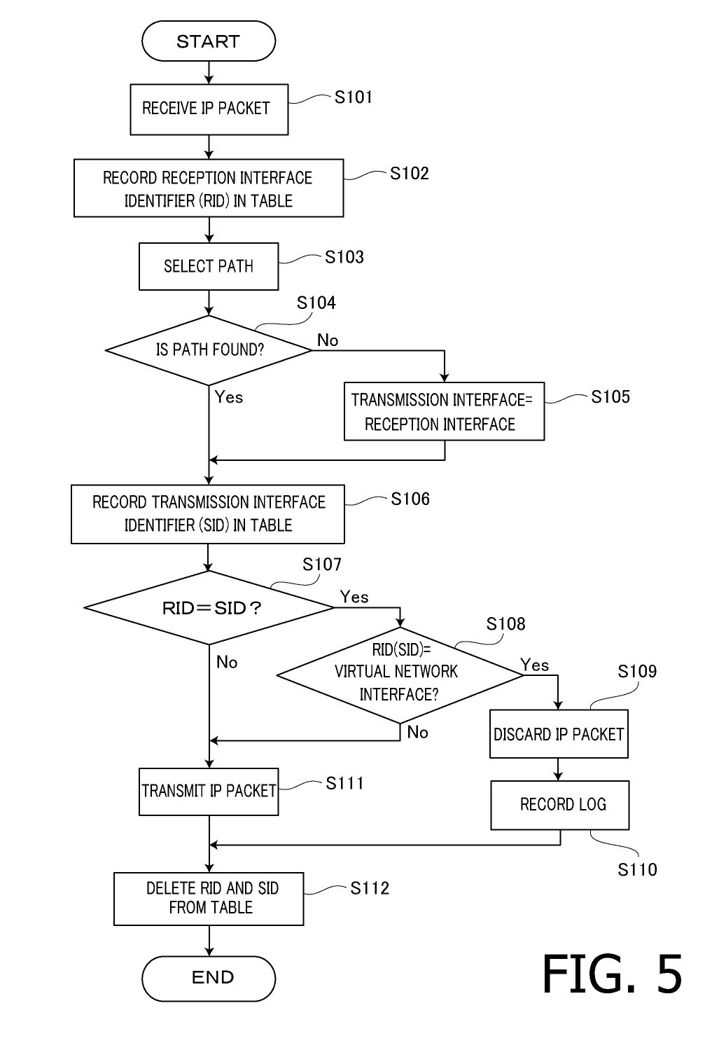

Next, the packet relay process executed by the host 30 is explained. FIG. 5 is a flowchart illustrating the packet relay process.

First, an IP packet addressed to the host 30 from the network is subjected to a reception process by the reception unit 31 using one of the interfaces (IF0, IF1, IF2 . . . ) of the network interface unit 35 (S101).

When receiving an IP packet, the reception processing unit 31 records information such as a reception time and a packet length of the received IP packet in the packet transmission/reception management table 34, and records the reception interface identifier (RID) for identifying the interface used to receive the IP packet in the packet transmission/reception management table 34 (S102). For example, when the IP packet is received through the Ethernet interface (IF0), the reception processing unit 31 records, as the reception interface identifier (RID), “IF0” for identifying the interface in the packet transmission/reception management table 34. When the IP packet is received through the virtual network interface (IF2), the reception processing unit 31 records, as the reception interface identifier (RID), “IF2” for identifying the interface in the packet transmission/reception management table 34. Same applies to the case of the PPoE interface. Next, the reception processing unit 31 sends the IP packet to the route control unit 32.

The route control unit 32 selects a transmission path for the IP packet received from the reception processing unit 31 (S103). Specifically, the route control unit 32 refers to a routing table (not shown), and selects a path using a longest match method with respect to the destination address of the IP packet. When a path corresponding to the destination address of the IP packet is found (S104: YES), the route control unit 32 records, in the packet transmission/reception management table 34, the transmission interface identifier (SID) for identifying the transmission interface for the selected path, in such a manner that the transmission interface identifier (SID) is associated with the above described reception interface identifier (RID) (S106). Specifically, when the transmission interface for the selected path is the Ethernet interface (IF0), the route control unit 32 records “IF0” in the packet transmission/reception management table 34 as the transmission interface identifier (SID). When the transmission interface for the selected path is the virtual network interface (IF2), the route control unit 32 records “IF2” in the packet transmission/reception management table 34 as the transmission interface identifier (SID). The reception time and the packet length of the received IP packet recorded by the reception processing unit 31 in the packet transmission/reception management table 34 may be used to associate the transmission interface identifier (SID) with the reception interface identifier (RID).

When a path corresponding to the destination address of the IP packet is not found (S104: NO), the route control unit 32 sets the interface which was used to receive the IP packet, as the transmission interface to be used to transmit the IP packet so that the received IP packet is returned to the sender (S105). Then, the process proceeds to S106 where the route control unit 32 records, as the transmission interface identifier (SID), the ID being the same as the reception interface identifier (RID) in the packet transmission/reception management table 34 in such a manner that the ID is associated with the reception interface identifier (RID). Then, the IP packet is sent to the transmission processing unit 33.

Next, based on the packet reception time and the packet length of the received IP packet, the transmission processing unit 33 reads the reception interface identifier (RID) and the transmission interface identifier (SID) from the packet transmission/reception management table 34. Then, the transmission processing unit 33 makes a comparison between the reception interface identifier (RID) and the transmission interface identifier (SID) read from the table 34 to judge whether both of them are the interface identifier of the same virtual network. Specifically, the transmission processing unit 33 judges whether the reception interface identifier (RID) is identical with the transmission interface identifier (SID) (S017). When the reception interface identifier (RID) is identical with the transmission interface identifier (SID) (S107: YES), the transmission processing unit 33 judges whether the identifiers are the identifier of the virtual network interface (S108).

When the reception/transmission interface identifiers are the identifier of the virtual network interface (S108: YES), the transmission processing unit 33 discards the IP packet to invalidate transmission of the IP packet (S109), and records a log concerning the IP packet (S110). As a log, a destination of the IP packet, IP header information of the sender, a virtual network interface name and the number of discarded IP packets are recorded. By recording such a log, it becomes possible to notify a network operator of the fact that an IP packet has been discarded due to a loop. Furthermore, the network operator is able to correct such a defect on the network by checking, for example, the routing information based on the information in the log. After recordation of the log is finished, the process proceeds to S112.

When the reception interface identifier (RID) and the transmission interface identifier (SID) are not the interface identifier of the same virtual network, i.e., when the both interface identifiers are not identical with each other (S107: NO), or the both network identifiers are not the identifier of the virtual network interface even if the both identifiers are identical with each other (S108: NO), the transmission processing unit 33 executes the transmission process for the IP packet by using one of the interfaces corresponding to the transmission interface identifier (SID) (S111). Then, the transmission processing unit 33 deletes a set of registered information including the reception interface identifier (RID) and the transmission interface identifier (SID) from the packet transmission/reception management table 34 (S112).

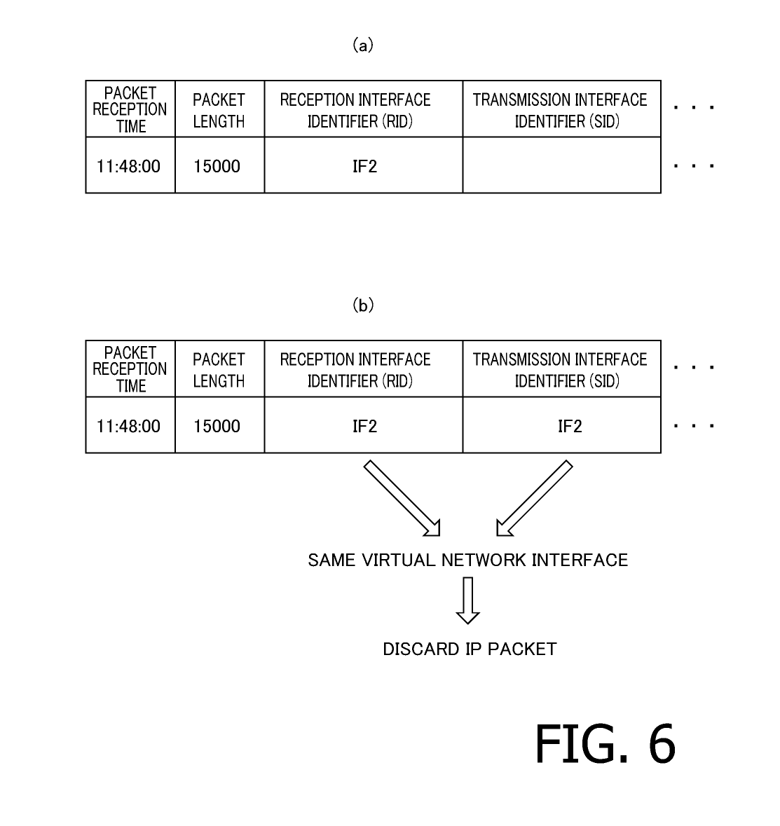

As an example, let us consider a case where an IP packet transferred through a virtual network is received by the virtual network interface (IF2). In this case, first the received IP packet is subjected to the reception process, such as decapsulation, in the virtual network interface (IF2). As shown in FIG. 6(a), the reception processing unit 31 records, as the reception interface identifier (RID), “IF2” identifying the virtual network interface (IF2) in the packet transmission/reception management table 34. Then, the received IP packet is sent to the route control unit 32.

The route control unit 32 refers to a routing table and selects a transmission path based on the destination address of the IP packet. When a path corresponding to the destination address is not found in the routing table, the route control unit 32 determines that the IP packet should be returned to the host being the sender. In this case, as shown in FIG. 6B, the route control unit 32 records, as the transmission interface identifier (SID), the ID “IF2” being the same as the reception interface identifier in the packet transmission/reception management table 34 in such a manner that the ID “IF2” is associated with the reception interface identifier (RID). Same applies to the case where a path is selected and the transmission interface of the selected transmission path is the virtual network interface (IF2).

Then, the transmission processing unit 33 judges that the reception interface identifier (RID) and the transmission interface identifier (SID) are identical with each other, and the “IF2” is the identifier of the virtual interface. Therefore, the received IP packet is discarded, and the transfer of the IP packet to the host being the sender is invalidated. Consequently, it becomes possible to prevent occurrence of an infinite loop of a packet through a virtual network.

As described above, according to the embodiment, even when a loop of a particular packet occurs due to, for example, an error in setting information of the routing table, occurrence of an undesired loop can be prevented by discarding the packet. Consequently, it becomes possible to prevent the band of the line from being oppressed, and thereby to protect other packets. Furthermore, according to the embodiment, the transmission processing unit 33 of the host 30 compares the reception interface identifier with the transmission interface identifier, and when the both identifiers are the same virtual network interface, the transmission processing unit 33 discards the received packet to prevent occurrence of an infinite loop of a packet. Such a configuration eliminates the need for modifying the structure of the packet. Furthermore, since the advantage can be achieved by installing the function of detecting a loop in one of a relaying device at the entrance of the tunneling and a relaying device at an exit of the tunneling, there is no necessity to install the function of detecting a loop on all of the relaying devices on the network.

It is understood that the packet relaying device according to the invention is not limited to the above described illustrative embodiments, and can be varied without departing from the scope of the invention. In the above described embodiment, the reception interface identifier (RID) and the transmission interface identifier (SID) are recorded in the packet transmission/reception management table 34, and the judgment as to whether a loop is caused is made based on these identifiers. However, the present invention is not limited to such a configuration. For example, when the host 30 receives an IP packet, the host 30 may judge whether a loop is caused by using an “attribute” of the IP packet including various types of information such as routing information, the type of the packet or priority of the packet, which are managed together with IP packet data.

In this case, first, the reception processing unit 31 records, as the attribute of the received IP packet, the identifier (the reception interface identifier (RID)) of the interface through which the IP packet was received. Then, a path is selected by the route control unit 32, and the transmission processing unit 33 compares the identifier of the transmission interface of the selected path (the transmission interface identifier (SID)) with the reception interface identifier (RID) recorded by the reception processing unit 31 as the attribute. When the both identifiers are identical with each other and the both identifiers indicate the virtual network interface, the host 30 judges that a loop is caused and discards the IP packet. With this configuration, it becomes possible to prevent occurrence of a loop even when a table is not recorded.

The packet relaying device according to the present invention can be provided as a router, and can also be provided as a program installed in a personal computer as an application program. Furthermore, the present invention can be applied to various types of tunneling technologies, such as 6RD (IPv6 Rapid Deployment), IPv4 over IPv6, IPv4 over IPv4, IPv6 over IPv6, Ethernet over IPv4, Ethernet over IPv6 and Ethernet over MPLS.
Pa, Pb, Pc IP packet
IF0, IF1, IF2 interface
VIF1, VIF2 virtual network interface
1 first network
2 second network
3 third network
4 virtual network
10, 20, 30 host
31 reception processing unit
32 route control unit
33 transmission processing unit
34 packet transmission/reception management table
35 network interface unit

1. A packet relaying device, comprising:
a plurality of interfaces including a virtual network interface;
a reception processing unit configured to receive a packet through one of the plurality of interfaces;
a route control unit configured to execute a route selection to determine, from among the plurality of interfaces, an interface used to transmit the received packet; and
a transmission processing unit configured to discard the received packet when the interface which was used to receive the packet in the reception processing unit and the interface determined by the route control unit are identical with each other, and are the virtual network interface.

2. The packet relaying device according to claim 1,
wherein the transmission processing unit is configured to execute a transmission process for the packet through the interface determined by the route control unit when the interface which was used to receive the packet in the reception processing unit and the interface determined by the route control unit are not identical with each other, or when the interface which was used to receive the packet in the reception processing unit and the interface determined by the route control unit are identical with each other but are not the virtual network interface.

3. The packet relaying device according to claim 1, further comprising:
a storage unit configured to store a reception interface identifier for identifying the interface which was used to receive the packet and a transmission interface identifier for identifying the interface determined to be used for transmission of the packet, in such a manner that the reception interface identifier and the transmission interface identifier are associated with each other,
wherein:
the reception processing unit stores, in the storage unit, an identifier of the interface which was used to receive the packet, as the reception interface identifier;
the route control unit stores, in the storage unit, an identifier of the interface determined by the route selection, as the transmission interface identifier; and
the transmission processing unit makes a comparison between the reception interface identifier and the transmission interface identifier stored in the storage unit.

4. The packet relaying device according to claim 1, wherein the plurality of interfaces are logical ports.

5. A packet relaying method, comprising the steps of:
receiving a packet through one of a plurality of interfaces including a virtual network interface;
executing a route selection to determine, from among the plurality of interfaces, an interface used to transmit the received packet; and
discarding the received packet when the interface which was used to receive the packet and the interface determined by the route selection are identical with each other, and are the virtual network interface.

6. (canceled)

7. The packet relaying method according to claim 5,
wherein the step of discarding includes executing a transmission process for the packet through the determined interface when the interface which was used to receive the packet and the interface determined by the route selection are not identical with each other, or when the interface which was used to receive the packet and the interface determined by the route selection are identical with each other but are not the virtual network interface.

8. The packet relaying method according to claim 5, further comprising the step of:
storing, in a storage unit, a reception interface identifier for identifying the interface which was used to receive the packet and a transmission interface identifier for identifying the interface determined to be used for transmission of the packet, in such a manner that the reception interface identifier and the transmission interface identifier are associated with each other,
wherein:
in the step of receiving, an identifier of the interface which was used to receive the packet is stored in the storage unit as the reception interface identifier;
in the step of executing, an identifier of the interface determined by the route selection is stored in the storage unit as the transmission interface identifier; and
in the step of discarding, a comparison is made between the reception interface identifier and the transmission interface identifier stored in the storage unit.

9. The packet relaying method according to claim 5, wherein the plurality of interfaces are logical ports.

10. A computer readable medium having computer readable instruction stored thereon, which, when executed by a processor of a computer, configures the processor to perform the steps of:
receiving a packet through one of a plurality of interfaces including a virtual network interface;
executing a route selection to determine, from among the plurality of interfaces, an interface used to transmit the received packet; and
discarding the received packet when the interface which was used to receive the packet and the interface determined by the route selection are identical with each other, and are the virtual network interface.

11. The computer readable medium according to claim 10,
wherein the step of discarding includes executing a transmission process for the packet through the determined interface when the interface which was used to receive the packet and the interface determined by the route selection are not identical with each other, or when the interface which was used to receive the packet and the interface determined by the route selection are identical with each other but are not the virtual network interface.

12. The computer readable medium according to claim 10, wherein the instruction further causes the computer to perform the step of:
storing, in a storage unit, a reception interface identifier for identifying the interface which was used to receive the packet and a transmission interface identifier for identifying the interface determined to be used for transmission of the packet, in such a manner that the reception interface identifier and the transmission interface identifier are associated with each other,
wherein:
in the step of receiving, an identifier of the interface which was used to receive the packet is stored in the storage unit as the reception interface identifier;
in the step of executing, an identifier of the interface determined by the route selection is stored in the storage unit as the transmission interface identifier; and
in the step of discarding, a comparison is made between the reception interface identifier and the transmission interface identifier stored in the storage unit.

13. The computer readable medium according to claim 10, wherein the plurality of interfaces are logical ports.
